(19) United States
(12) Patent Application Publication
(10) Pub. No.: US 2016/0076602 A1
(43) Pub. Date: Mar. 17, 2016

(54) FREEWHEEL MECHANISM

(71) Applicant: EFNEO SP. Z.O.O, Warsaw (PL)

(72) Inventors: Wiktor MIGASZEWSKI, Warsaw (PL); Boguslawa JANOWSKA, Grudziadz (PL); Stefan MIGASZEWSKI, Grodzisk Mazowiecki (PL); Fryderyk MIGASZEWSKI, Warsaw (PL); Franciszek MIGASZEWSKI, Warsaw (PL)

(73) Assignee: EFNEO SP. Z.O.O, Warsaw (PL)

(21) Appl. No.: 14/785,521

(22) PCT Filed: May 29, 2013
(86) PCT No.: PCT/PL2013/000071

§ 371 Date: Oct. 19, 2015

(30) Foreign Application Priority Data
Apr. 28, 2013 (PL) P.403695

(51) Int. Cl. F16D 41/066

(52) U.S. Cl. CPC F16D 41/066; F16D 2041/0646

(57) ABSTRACT

A freewheel mechanism comprising grips, mating with rolling-and-gripping rollers, that are mating with concave raceway, wherein it contains the rolling-and-rotating rollers, wherein the radius of the rolling-and-rotating roller is smaller than the radius of the rolling-and-gripping roller, wherein one or more rolling-and-rotating rollers and one or more rolling-and-gripping rollers are coaxially connected with each other, wherein each rolling-and-rotating roller is mating with one stationary interlock or rotary interlock, or rotary interlock provided with bearing, wherein each rolling-and-rotating roller is mating with one convex path, wherein the radius of the concave raceway is equal to the sum of the radius of the rolling-and-gripping roller, the radius of the rolling-and-rotating roller and the radius of the convex path. The disclosure relates also to a freewheel mechanism containing internally situated convex raceway and outside situated grips, concave paths and interlocks.

The invention relates to a freewheel mechanism, usable for the transmission of torque in machines.

The freewheel mechanisms are known from patent descriptions U.S. Pat. No. 3,166,169 and U.S. Pat. No. 4,932,508, in which the permanent contact of gripping roller with roller raceway is ensured by the pressure exerted by spring. The effect of this pressure is a friction between the roller and a spring, taking place during the run of freewheel mechanism in rolling mode, and connected with this lowering of efficiency. The unfavorable feature of these freewheel mechanisms is also a fact, that the rollers do not ensure coaxiality of roller raceway and the ring containing the griping surfaces, therefore in order to ensure this, it is necessary to use additional element in the form of bearing.

The essence of invention is a development of such freewheel mechanism, which is ensuring coaxiality of mating rotary elements, owing to which it is not necessary to use for this purpose a bearing. The essence of invention is also a development of such freewheel mechanism which is ensuring coaxiality of mating rotary elements, featuring a simple structure and a low cost of production. The purpose of invention is also a development of such freewheel mechanism, in which the transition from rolling mode into gripping one takes place rapidly, owing to the permanent contact of rolling-and-gripping rollers with the raceway. The purpose of invention is also a development of such freewheel mechanism, in which the permanent contact of gripping rollers with the raceway is achieved at a little friction, owing to rolling of compound rollers over the raceway. The aim of invention is also a development of such freewheel mechanism, in which the abut of compound rollers against the interlocks is achieved at reduced friction, owing to the use of rotary interlocks or rotary interlocks provided with bearing, thus running of transmission is more smooth, and arising of the abrasive wear of rollers as well as unwanted clearances will take place considerably later, thus maintaining the decreased time of transition to gripping mode.

The freewheel mechanism according to the invention is characterized in that it contains the rolling-and-rotating rollers, whereas the radius of rolling-and-rotating roller is smaller than the radius of rolling-and-gripping roller. One or more rolling-and-rotating rollers and one or more rolling-and-gripping rollers are coaxially connected with each other. Each rolling-and-rotating roller is mating with one stationary interlock or rotary interlock, or rotary interlock provided with bearing. Each rolling-and-rotating roller is mating with one convex path. The radius of concave raceway is equal to the sum of radius of the rolling-and-gripping roller, radius of the rolling-and-rotating roller and radius of the convex path.

It is preferable, that freewheel mechanism contains rolling-and-rotating rollers and rolling-and-gripping rollers rigidly connected with each other.

It is preferable, that freewheel mechanism contains concave raceway situated on the internal surface of a concave raceway ring.

It is preferable, that freewheel mechanism contains the convex paths, which are situated on the rolling-and-rotating core.

It is preferable, that freewheel mechanism contains the convex paths, which are situated on the type II rolling-and-rotating core.

It is preferable, that freewheel mechanism contains the rotary interlock, which contains an interlock ring, which is rotationally mounted on an interlock axle.

It is preferable, that freewheel mechanism contains the rotary interlock provided with bearing, which contains a ring of interlock provided with bearing, which is mounted on the bearing, which then is mounted on the interlock axle.

It is preferable, that freewheel mechanism contains the interlock axle connected with an extension arm, that is connected with type II rolling-and-rotating core.

It is preferable, that freewheel mechanism contains a convex spring.

It is preferable, that freewheel mechanism contains the convex spring, which is mating with the rolling-and-rotating roller.

The invention relates also to a freewheel mechanism which is characterized in that it contains the rolling-and-rotating rollers, whereas the radius of rolling-and-rotating roller is smaller than the radius of rolling-and-gripping roller. One or more rolling-and-rotating rollers and one or more rolling-and-gripping rollers are coaxially connected with each other. Each rolling-and-rotating roller is mating with one stationary interlock or rotary interlock, or rotary interlock provided with bearing. Each rolling-and-rotating roller is mating with one concave path. The radius of concave path is equal to the sum of radius of the rolling-and-rotating roller, radius of the rolling-and-gripping roller and radius of the convex raceway.

It is preferable, that freewheel mechanism contains rolling-and-rotating rollers and rolling-and-gripping rollers rigidly connected with each other.

It is preferable, that freewheel mechanism contains convex raceway situated on the external surface of a convex raceway core.

It is preferable, that freewheel mechanism contains the concave paths, which are situated on the rolling-and-rotating ring.

It is preferable, that freewheel mechanism contains the concave paths, which are situated on the type II rolling-and-rotating ring.

It is preferable, that freewheel mechanism contains the rotary interlock, which contains an interlock ring, which is rotationally mounted on an interlock axle.

It is preferable, that freewheel mechanism contains the rotary interlock provided with bearing, which contains a ring of interlock provided with bearing, which is mounted on the bearing, which then is mounted on the interlock axle.

It is preferable, that freewheel mechanism contains the interlock axle connected with an extension arm, that is connected with type II rolling-and-rotating core.

It is preferable, that freewheel mechanism contains a concave spring.

It is preferable, that freewheel mechanism contains the concave spring, which is mating with the rolling-and-rotating roller.

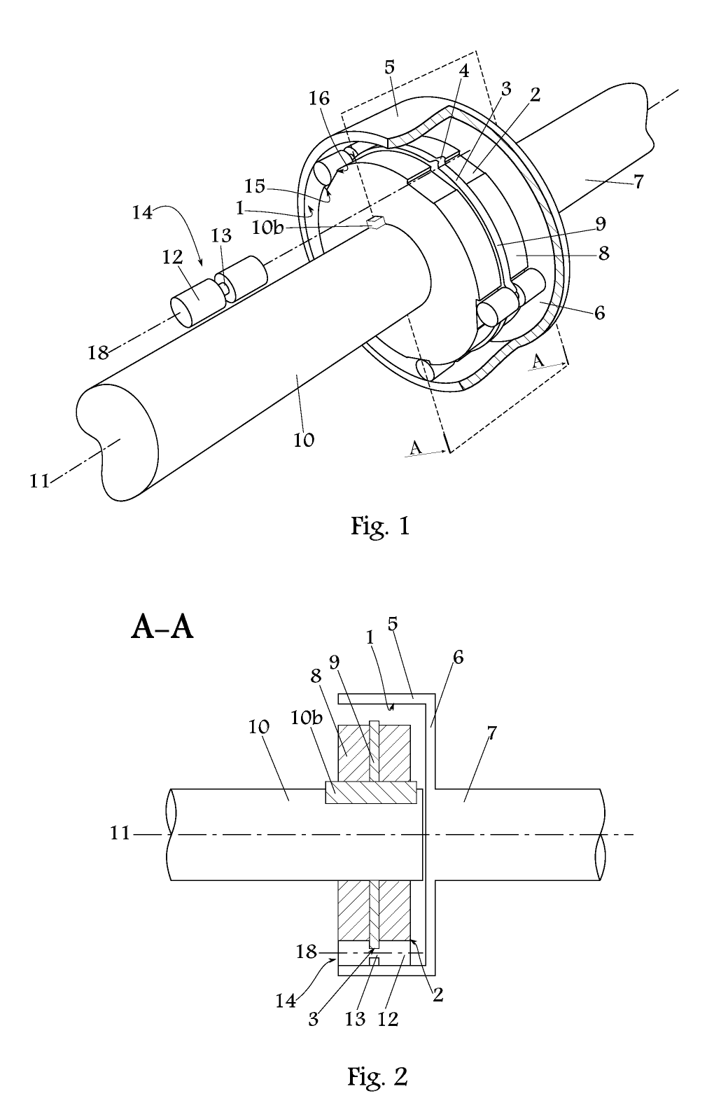

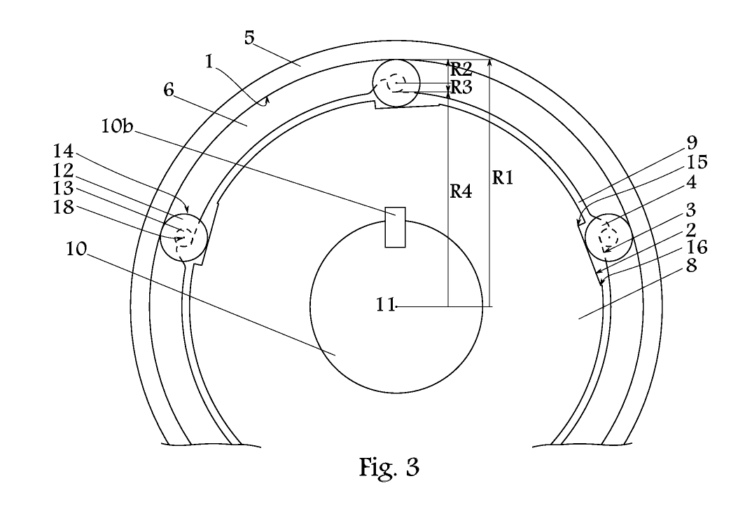

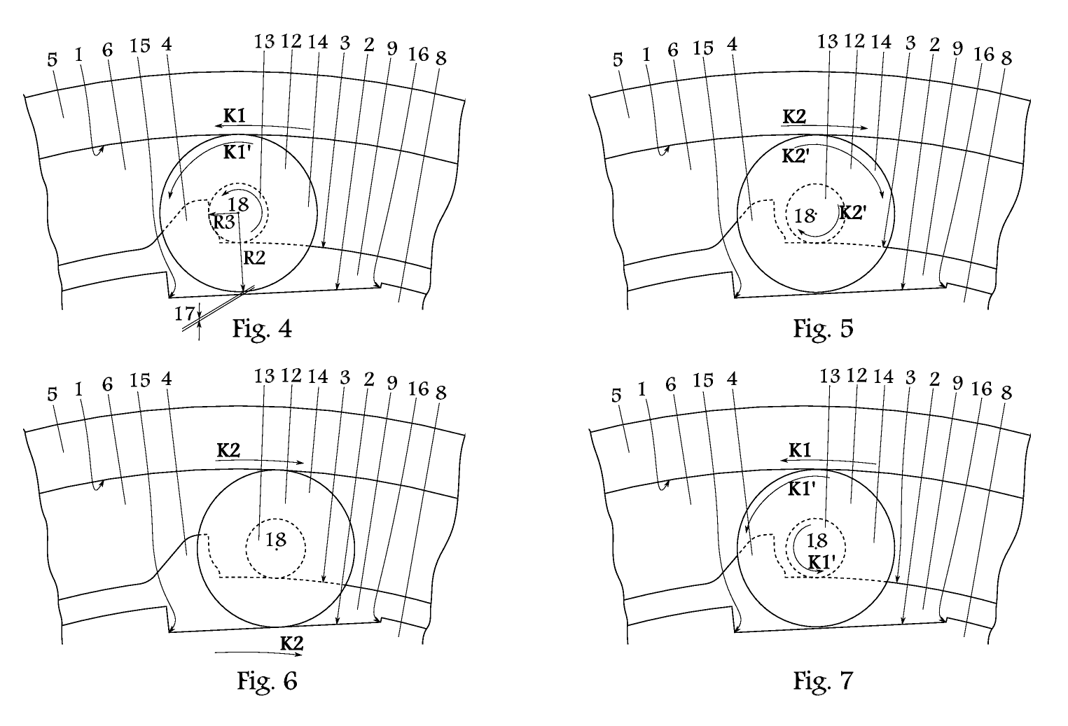

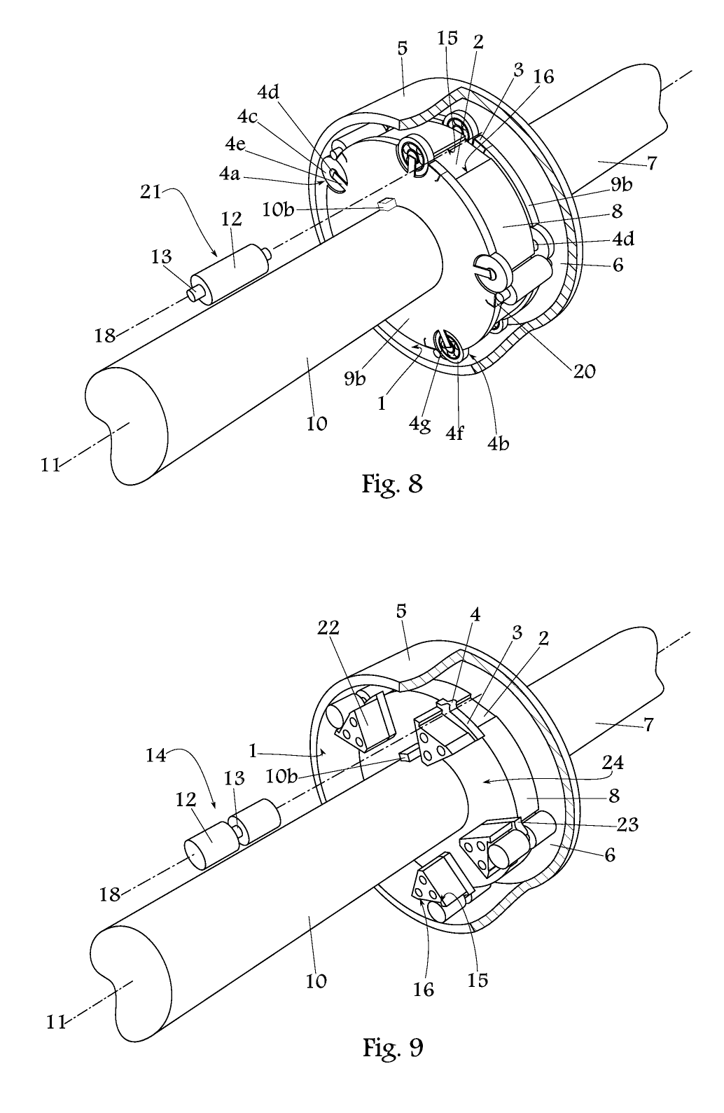

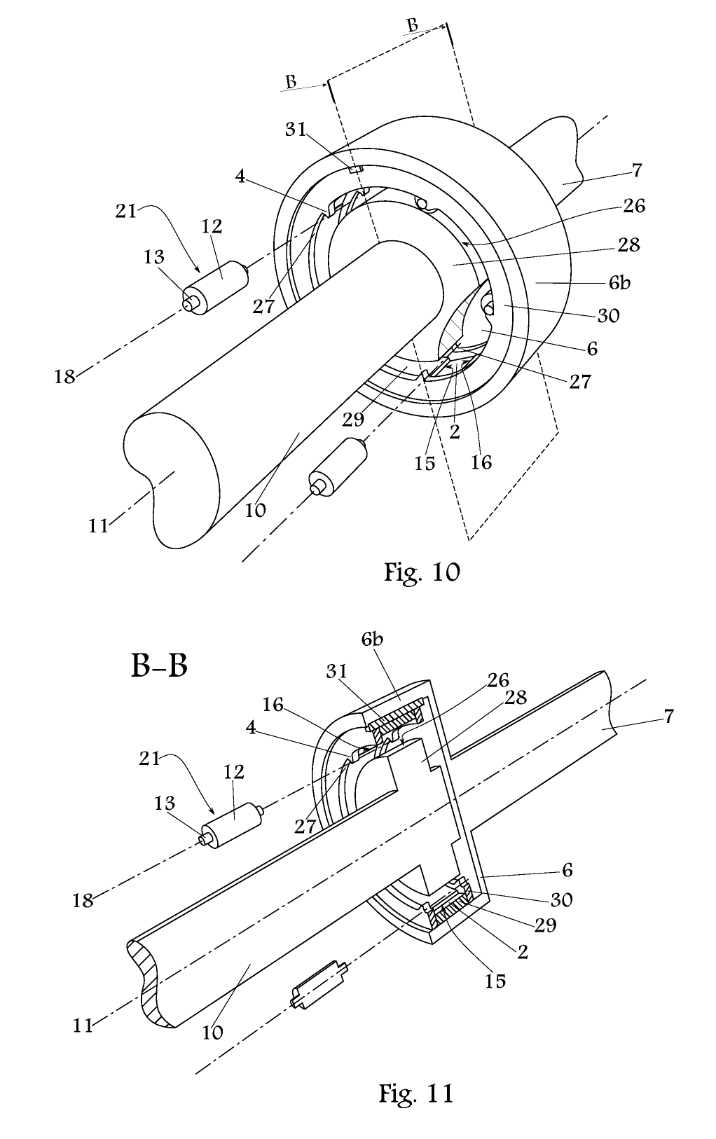

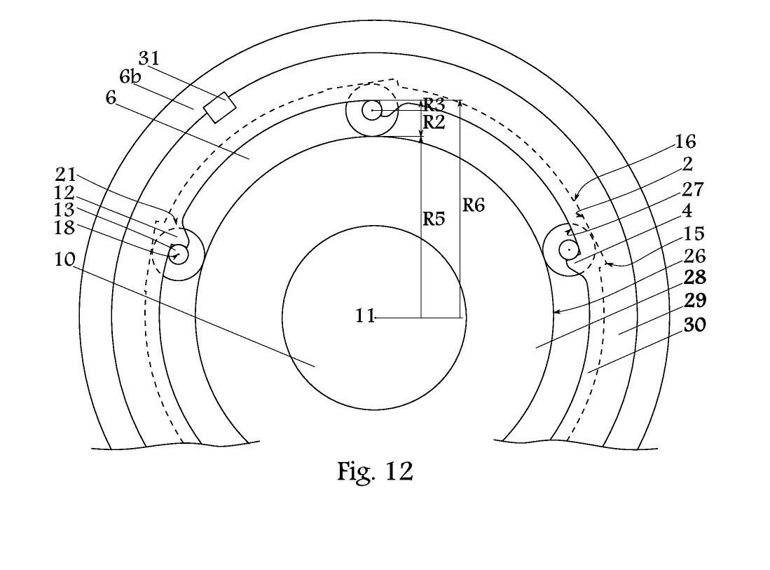

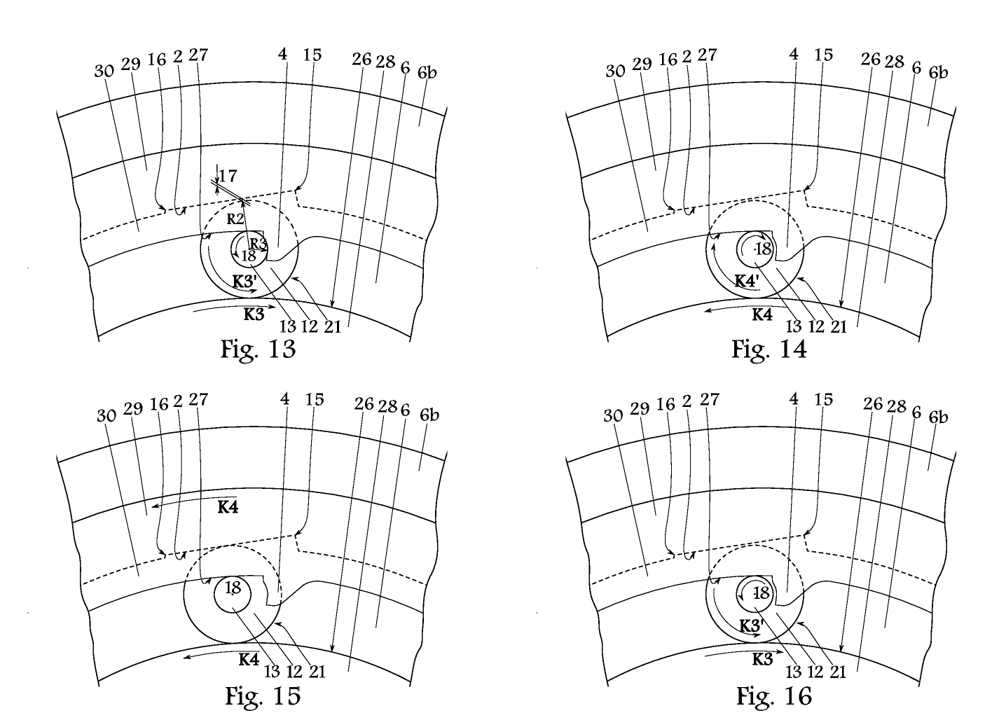

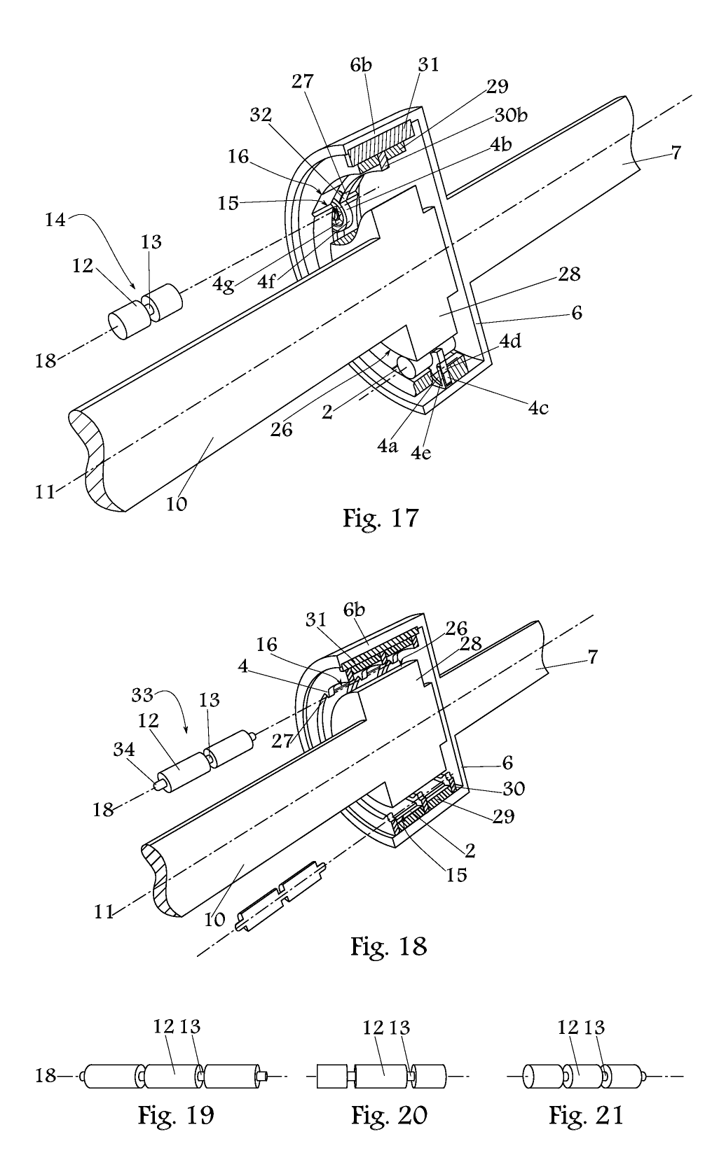

The invention was explained in detail in the embodiment, as shown in the drawing, in which FIG. 1 shows an embodiment I of a mechanism according to the invention—the axonometric view of freewheel mechanism, with cut out section of concave raceway ring, as well as the led out compound roller, FIG. 2 depicts embodiment I of the mechanism according to invention—the section of freewheel mechanism, FIG. 3 shows an embodiment I of a mechanism according to the invention—diagram of freewheel mechanism with radiuses marked, FIG. 4 shows an embodiment I of a mechanism according to the invention—diagram of freewheel mechanism in rolling mode, FIG. 5 shows an embodiment I of a mechanism according to the invention—diagram of freewheel mechanism in the process of transition from rolling mode to gripping mode, FIG. 6 shows an embodiment I of a mechanism according to the invention—diagram of freewheel mechanism in gripping mode, FIG. 7 shows an embodiment I of a mechanism according to the invention—diagram of freewheel mechanism in the process of transition from gripping mode to rolling mode, FIG. 8 shows an embodiment II of a mechanism according to the invention—axonometric view of freewheel mechanism, with cut out section of concave raceway ring, as well as the led out compound roller, FIG. 9 depicts an embodiment III of a mechanism according to the invention—axonometric view of freewheel mechanism, with cut out section of concave raceway ring, as well as led out compound roller, FIG. 10 shows an embodiment IV of a mechanism according to the invention—axonometric view of freewheel mechanism, with cut out section of convex raceway core, as well as led out compound rollers, FIG. 11 shows an embodiment IV of a mechanism according to the invention—axonometric view, with cut out section along the cutting plane, as well as led out compound rollers, FIG. 12 shows an embodiment IV of a mechanism according to the invention—diagram of freewheel mechanism with radiuses marked, FIG. 13 shows an embodiment IV of a mechanism according to the invention—diagram of freewheel mechanism in rolling mode, FIG. 14 shows an embodiment IV of a mechanism according to the invention—diagram of freewheel mechanism in the process of transition from rolling mode to gripping mode, FIG. 15 shows an embodiment IV of a mechanism according to the invention—diagram of freewheel mechanism in gripping mode, FIG. 16 shows an embodiment IV of a mechanism according to the invention—diagram of freewheel mechanism in the process of transition from gripping mode to rolling mode, FIG. 17 shows an embodiment V of a mechanism according to the invention—axonometric view, with cut out sections along the cutting plane, in the convex raceway core and in gripping ring, as well as the led out compound roller, FIG. 18 shows an embodiment VI of a mechanism according to the invention—axonometric view of freewheel mechanism, with cut out section along the cutting plane, as well as the led out compound rollers, FIG. 19-21 show an embodiment VII of a mechanism according to the invention—axonometric views of compound rollers.

### EMBODIMENT I

In embodiment I of a freewheel mechanism according to the invention, as shown in FIG. 1-7, the freewheel mechanism is equipped with concave raceway 1, grips 2, convex paths 3 and stationary interlocks 4. Concave raceway 1, which is a curved surface with curvature radius R1, is situated on the internal surface of a concave raceway 1 ring 5, and which is rigidly connected with a flange 6 and ring axle 7. The grips 2 are located on gripping cores 8. The convex paths 3 and stationary interlocks 4 are situated on the rolling-and-rotating core 9. The gripping cores 8 and rolling-and-rotating core 9 are rigidly connected with core axle 10, preventing their rotation with regard to each other, achieved by means of an element 10b interlocking the rotation of cores.

The grips 2, convex paths 3 and stationary interlocks 4 are circumferentially arranged on the gripping cores 8 and on the rolling-and-rotating core 9, at a constant radial distance from the freewheel mechanism axis of rotation 11, and at a constant angular relation to the radius derived from the axis 11.

The freewheel mechanism contains the rolling-and-gripping rollers 12 and rolling-and-rotating rollers 13, rigidly and coaxially connected with each other, making up the type A compound rollers 14. The rolling-and-gripping rollers 12 have radiuses R2, which are larger than the radiuses R3 of rolling-and-rotating rollers 13. Each type A compound roller 14 consists of two rolling-and-gripping rollers 12, between which a rolling-and-rotating roller 13 is placed.

Each rolling-and-gripping roller 12 is mating with a concave raceway 1 and with one grip 2. The farther extremity 15 of a grip 2 is situated at a distance from concave raceway 1 which is larger from the diameter (i.e. twice as large as radius R2) of the rolling-and-gripping roller 12. The nearer extremity 16 of a grip 2 is situated at a distance from concave raceway 1, which is smaller than the diameter (i.e. twice as large as the radius R2) of the rolling-and-gripping roller 12.

Each rolling-and-rotating roller 13 is mating with one stationary interlock 4 and one convex path 3, having a form of arched surface with radius R4. The stationary interlock 4 is placed at the end of convex path 3.

As shown in FIG. 3, the radius R1 of concave raceway 1 is equal to the sum of the radius R2 of the rolling-and-gripping roller 12, the radius R3 of the rolling-and-rotating roller 13 and the radius R4 of the convex path 3.

The type A compound roller 14 is situated between the convex path 3 and concave raceway 1 in a way, which prevents its radial displacement with regard to the freewheel mechanism axis of rotation 11. The type A compound roller 14, during whole operation of freewheel mechanism, is in contact with concave raceway 1 as well as with convex path 3. The concave raceway 1, convex path 3 as well as type A compound roller 14 are acting as load carrying elements, which enable maintaining coaxiality of the concave raceway 1 ring 5 and rolling-and-rotating core 9, over the whole period of freewheel mechanism operation, also under the action of considerable forces, owing to which the freewheel mechanism according to invention is also acting as a bearing.

Operation of freewheel mechanism according to embodiment I was shown in diagrams depicted in FIG. 4-7, which are presenting in enlargement the type A compound roller 14 with mating elements. At given moment freewheel mechanism is operating in the rolling or gripping mode, or a transition between these modes takes place.

In the process of freewheel mechanism operation in rolling mode the ring axle 7, the flange 6 and the concave raceway 1 ring 5, are rotating in a direction K1. As shown in FIG. 4, the concave raceway 1 is turning the rolling-and-gripping roller 12, which is transferring the torque in direction K1′ onto the rolling-and-rotating roller 13, and which is abut against the stationary interlock 4. The torque of concave raceway 1 is not transferred onto the gripping cores 8.

In order to ensure the possibility of freewheel mechanism operation in rolling mode, the running clearance 17 is kept between the rolling-and-gripping roller 12, and the grip 2. The running clearance 17 is a distance from the roller axis of rotation 18 to the grip 2, reduced by the radius R2 of the rolling-and-gripping roller 12, measured at the moment, when the roller axis of rotation 18 is situated at a distance equal to the radius R3 of the rolling-and-rotating roller 13 from the stationary interlock 4. The running clearance 17 allows for a free rotation of the rolling-and-gripping roller 12, without friction against grip 2. The running clearance 17 should be as small as possible, as this enables more rapid transition of freewheel mechanism from rolling mode to gripping mode, which is described below. The width of running clearance 17 depends on the position of stationary interlock 4 with regard to grip 2, as well as on the angular position of the whole rolling-and-rotating core 9 with regard to gripping cores 8, and can be adjusted by changing the mutual position of these elements.

In the process of transition from rolling mode to gripping mode of freewheel mechanism, as shown in FIG. 5, the concave raceway 1 is rotating in the direction K2 and turns the rolling-and-gripping roller 12, which is transferring the torque in the direction K2′ onto the rolling-and-rotating roller 13, which is rolling over the convex path 3 up to the moment, in which the rolling-and-gripping roller 12 is gripped between the grip 2, and concave raceway 1. The type A compound roller 14 makes a move in a direction K2, from stationary interlock 4 to the grip 2.

In the course of operation of freewheel mechanism in gripping mode the ring axle 7, the flange 6 and the concave raceway 1 ring 5 are rotating in the direction K2. As shown in FIG. 6, the rolling-and-gripping rollers 12, gripped between concave raceway 1 and a grip 2, are transferring the torque from concave raceway 1 onto the gripping cores 8, which are transferring the torque in a direction K2 further onto the core axle 10.

In the process of transition from gripping mode to rolling mode of freewheel mechanism, as shown in FIG. 7, the concave raceway 1 is rotating in direction K1. The concave raceway 1 is turning the rolling-and-gripping roller 12, which is transferring the torque in direction K1′ onto the rolling-and-rotating roller 13, which is rolling over the convex path 3, up to the stationary interlock 4. The type A compound roller 14 makes a move in the direction K1, from the grip 2 to the stationary interlock 4.

### EMBODIMENT II

In the freewheel mechanism according to embodiment II as presented FIG. 8 the convex paths 3 have a form of curved surfaces of convex springs 20, which are mounted in the type II rolling-and-rotating cores 9b. The convex springs 20 are pushing the rolling-and-rotating rollers 13 outside, towards the concave raceway 1, owing to which the rolling-and-gripping rollers 12 are touching the concave raceway 1 also in the situation, when the surfaces of mating elements of freewheel mechanism became subjected to abrasive wear and the clearances appeared between them. Permanent contact of the rolling-and-gripping rollers 12 with the concave raceway 1 allows the freewheel mechanism for a rapid change of working mode from rolling to gripping one.

Each rolling-and-gripping roller 12 is situated between two rolling-and-rotating rollers 13 and is coaxially connected with them, making up the type B compound roller 21. Freewheel mechanism is equipped with one gripping core 8 and two type II rolling-and-rotating cores 9b.

The freewheel mechanism contains rotary interlocks 4a and rotary interlocks provided with bearing 4b, with which the rolling-and-rotating rollers 13 are mating at the friction lower than that in the process of mating with stationary interlocks 4. Every rotary interlock 4a contains the interlock ring 4c, rotationally mounted on the interlock axle 4d, which by the means of extension arm 4e is connected with type II rolling-and-rotating core 9b, then connected with core axle 10. Each rotary interlock provided with bearing 4b contains the ring 4f of interlock provided with bearing, mounted on a bearing 4g, which is mounted on the interlock axle 4d. Owing to reduced friction, the abrasive wear of rolling-and-rotating rollers 13 and caused by this clearances are smaller and thus the time of transition to gripping mode remains fairly short.

### EMBODIMENT III

The freewheel mechanism according to embodiment III, as presented in FIG. 9 contains the gripping bases 22 as well as rolling-and-rotating bases 23, which are rigidly connected with gripping core 8, owing to which the mutual orientation of all grips 2, convex paths 3 and stationary interlocks 4 remains unchanged. It is possible to place other elements of the device, the part of which is freewheel mechanism, in the spaces 24 between bases 22 and 23, which permits to obtain more compact structure.

### EMBODIMENT IV

In embodiment IV of the freewheel mechanism according to invention, as shown in FIG. 10-16, the freewheel mechanism is equipped with convex raceway 26, grips 2, concave paths 27 and stationary interlocks 4. The convex raceway 26, which is a curved surface with a curvature radius R5, is situated on the external surface of the convex raceway 26 core 28, which is rigidly connected with core axle 10. The grips 2 are located on a gripping ring 29. The concave paths 27 and stationary interlocks 4 are situated on rolling-and-rotating rings 30. The gripping ring 29 and the rolling-and-rotating rings 30 are rigidly connected with flange ring 6b, flange 6 and ring axle 7, preventing their rotation with regard to each other, achieved by means of element 31 interlocking the rotation of rings.

The grips 2, concave paths 27 and stationary interlocks 4 are circumferentially arranged on the gripping ring 29 and the rolling-and-rotating rings 30, at a constant radial distance from the freewheel mechanism axis of rotation 11, and at a constant angular relation to the radius derived from the axis 11.

The freewheel mechanism contains the rolling-and-gripping rollers 12 and rolling-and-rotating rollers 13, rigidly and coaxially connected with each other, making up the type B compound rollers 21. The rolling-and-gripping rollers 12 have radiuses R2, which are larger than the radiuses R3 of rolling-and-rotating rollers 13. Each type B compound roller 21 consists of two rolling-and-rotating rollers 13, between which a rolling-and-gripping roller 12 is placed.

Each rolling-and-gripping roller 12 is mating with a convex raceway 26 and with one grip 2. The farther extremity 15 of a grip 2 is situated at a distance from convex raceway 26 which is larger than the diameter (i.e. twice as large as radius R2) of the rolling-and-gripping roller 12. The nearer extremity 16 of a grip 2 is situated at a distance from convex raceway 26, which is smaller than the diameter (i.e. twice as large as the radius R2) of the rolling-and-gripping roller 12.

Each rolling-and-rotating roller 13 is mating with one stationary interlock 4 and one concave path 27, having a form of arched surface with radius R6. The stationary interlock 4 is placed at the end of concave path 27.

As shown in FIG. 12, the radius R6 of concave path 27 is equal to the sum of the radius R3 of the rolling-and-rotating roller 13, the radius R2 of the rolling-and-gripping roller 12 and the radius R5 of the convex raceway 26.

The type B compound roller 21 is situated between the concave path 27 and convex raceway 26 in a way, which prevents its radial displacement with regard to the freewheel mechanism axis of rotation 11. The type B compound roller 21, during whole operation of freewheel mechanism, is in contact with convex raceway 26 as well as with concave path 27. The convex raceway 26, concave path 27 as well as type B compound roller 21 are acting as load carrying elements, which enable maintaining coaxiality of the convex raceway 26 core 28 and rolling-and-rotating rings 30, over the whole period of freewheel mechanism operation, also under the action of considerable forces, owing to which the freewheel mechanism according to invention is also acting as a bearing.

Operation of freewheel mechanism according to embodiment IV was shown in the diagrams depicted in FIG. 13-16, which are presenting in enlargement the type B compound roller 21 with mating elements. At given moment freewheel mechanism is operating in the rolling or gripping mode, or a transition between these modes takes place.

In the process of freewheel mechanism operation rolling mode the core axle 10 and the convex raceway 26 core 28, are rotating in the direction K3. As shown in FIG. 13, the convex raceway 26 is turning the rolling-and-gripping roller 12, which is transferring the torque in direction K3′ onto the rolling-and-rotating roller 13, which is abut against the stationary interlock 4. The torque of convex raceway 26 is not transferred onto the gripping ring 29.

In order to ensure the possibility of freewheel mechanism operation in rolling mode, the running clearance 17 is kept between the rolling-and-gripping roller 12, and the grip 2. The running clearance 17 is a distance from the roller axis of rotation 18 to the grip 2, reduced by the radius R2 of the rolling-and-gripping roller 12, measured at the moment, when the roller axis of rotation 18 is situated at a distance equal to the radius R3 of the rolling-and-rotating roller 13 from the stationary interlock 4. The running clearance 17 allows for a free rotation of the rolling-and-gripping roller 12, without friction against grip 2. The running clearance 17 should be as small as possible, as this enables more rapid transition of freewheel mechanism from rolling mode to gripping mode, which is described below. The width of running clearance 17 depends on the position of stationary interlock 4 with regard to grip 2, as well as on the angular position of the whole rolling-and-rotating rings 30 with regard to gripping ring 29, and can be adjusted by changing the mutual position of these elements.

In the process of transition from rolling mode to gripping mode of the freewheel mechanism, as shown in FIG. 14, the convex raceway 26 is rotating in the direction K4 and turns the rolling-and-gripping roller 12, which is transferring the torque in the direction K4′ onto the rolling-and-rotating roller 13, which is rolling over the concave path 27 up to the moment, in which the rolling-and-gripping roller 12 is gripped between grip 2, and convex raceway 26. The type B compound roller 21 makes a move in the direction K4, from stationary interlock 4 to the grip 2.

In the course of operation of freewheel mechanism in gripping mode the core axle 10 and the convex raceway 26 core 28 are rotating in the direction K4. As shown in FIG. 15, the rolling-and-gripping rollers 12, gripped between convex raceway 26 and grip 2, are transferring the torque from convex raceway 26 onto the gripping ring 29, which is transferring the torque in direction K4 further onto the ring axle 7.

In the process of transition from gripping mode to rolling mode of freewheel mechanism, as shown in FIG. 16, the convex raceway 26 is rotating in direction K3. The convex raceway 26 is turning the rolling-and-gripping roller 12, which transfers the torque in direction K3′ onto the rolling-and-rotating roller 13, which is rolling over concave path 27, up to the stationary interlock 4. The type B compound roller 21 makes a move in the direction K3, from the grip 2 to stationary interlock 4.

### EMBODIMENT V

In the freewheel mechanism according to embodiment V, as presented in FIG. 17 the concave paths 27 have a form of curved surfaces of concave springs 32, which are mounted in the type II rolling-and-rotating ring 30b. The concave springs 32 are pushing the rolling-and-rotating rollers 13 inside, towards the convex raceway 26, owing to which the rolling-and-gripping rollers 12 are touching the convex raceway 26 also in the situation, when the surfaces of mating elements of freewheel mechanism became subjected to abrasive wear and the clearances appeared between them. Permanent contact of the rolling-and-gripping rollers 12 with the convex raceway 26 allows the freewheel mechanism for a rapid change of working mode from rolling to gripping one.

Each rolling-and-rotating roller 13 is situated between two rolling-and-gripping rollers 12 and is coaxially connected with them, making up the type A compound roller 14. Freewheel mechanism is equipped with two gripping rings 29 and one type II rolling-and-rotating ring 30b.

The freewheel mechanism contains rotary interlocks 4a and rotary interlocks provided with bearing 4b, with which the rolling-and-rotating rollers 13 are mating at the friction lower than that in the process of mating with stationary interlocks 4. Every rotary interlock 4a contains the interlock ring 4c, rotationally mounted on the interlock axle 4d, which by the means of extension arm 4e is connected with type II rolling-and-rotating ring 30b, then connected with ring axle 7. Each rotary interlock provided with bearing 4b contains the ring 4f of interlock provided with bearing, mounted on a bearing 4g, which is mounted on the interlock axle 4d. Owing to reduced friction, the abrasive wear of rolling-and-rotating rollers 13 and caused by this clearances are smaller and thus the time of transition to gripping mode remains fairly short.

### EMBODIMENT VI

The freewheel mechanism according to embodiment VI as presented in FIG. 18 contains the type C compound rollers 33, from which every one consists of three rolling-and-rotating rollers 13 and two rolling-and-gripping rollers 12, coaxially and alternately connected with each other. The freewheel mechanism is equipped with three rolling-and-rotating rings 30 and two gripping rings 29. The use of a compound roller, which is built of greater number of rolling-and-rotating rollers 13 as well as rolling-and-gripping rollers 12 contributes to the increased stability of freewheel mechanism operation.

The type C compound rollers 33 are externally ended with hemispheres 34. The hemispherical ending of compound roller contributes to the reduction of friction with neighboring elements, e.g. with the housing.

### EMBODIMENT VII

The freewheel mechanism according to embodiment VII contains two or more rolling-and-gripping rollers 12 as well as two or more rolling-and-rotating rollers 13, rigidly and coaxially connected alternately with each other, within the confines of one compound roller, the significant length of which is increasing stability of the freewheel mechanism operation. Embodiments of such compound rollers are shown in FIG. 19-21.

The invention can be used in a transmission of torque in machines, which require the use of both a freewheel mechanism, as well as a bearing. In particular, the invention can be used in the mechanisms of the transmission of torque in bicycles.

1-20. (canceled)

21. A freewheel mechanism comprising:
grips, mating with rolling-and-gripping rollers, that are mating with concave raceway, wherein it contains rolling-and-rotating rollers, wherein the radius of the rolling-and-rotating roller is smaller than the radius of the rolling-and-gripping roller, wherein one or more rolling-and-rotating rollers and one or more rolling-and-gripping rollers are coaxially connected with each other, wherein each rolling-and-rotating roller is mating with one stationary interlock or rotary interlock, or rotary interlock provided with bearing, wherein each rolling-and-rotating roller is mating with one convex path, wherein the radius of the concave raceway is equal to the sum of the radius of the rolling-and-gripping roller, the radius of the rolling-and-rotating roller and the radius of the convex path.

22. The freewheel mechanism according to claim 21, wherein it contains the rolling-and-rotating rollers and the rolling-and-gripping rollers rigidly connected with each other.

23. The freewheel mechanism according to claim 21, wherein it contains the concave raceway situated on the internal surface of the concave raceway ring.

24. The freewheel mechanism according to claim 21, wherein it contains the convex paths, which are situated on the rolling-and-rotating core.

25. The freewheel mechanism according to claim 21, wherein it contains the convex paths, which are situated on the type II rolling-and-rotating core.

26. The freewheel mechanism according to claim 21, wherein it contains the rotary interlock, which contains the interlock ring, which is rotationally mounted on the interlock axle.

27. The freewheel mechanism according to claim 21, wherein it contains the rotary interlock provided with bearing, which contains the ring of interlock provided with bearing, which is mounted on the bearing, which then is mounted on the interlock axle.

28. The freewheel mechanism according to claim 21, wherein it contains the interlock axle connected with the extension arm, that is connected with the type II rolling-and-rotating core.

29. The freewheel mechanism according to claim 21, wherein it contains the convex spring.

30. The freewheel mechanism according to claim 21, wherein it contains the convex spring, which is mating with the rolling-and-rotating roller.

31. The freewheel mechanism containing grips, mating with rolling-and-gripping rollers, that are mating with convex raceway, wherein it contains rolling-and-rotating rollers, wherein the radius of the rolling-and-rotating roller is smaller than the radius of the rolling-and-gripping roller, wherein one or more rolling-and-rotating rollers and one or more rolling-and-gripping rollers are coaxially connected with each other, wherein each rolling-and-rotating roller is mating with one stationary interlock or rotary interlock, or rotary interlock provided with bearing, wherein each rolling-and-rotating roller is mating with one concave path, wherein the radius of the concave path is equal to the sum of the radius of the rolling-and-rotating roller, the radius of the rolling-and-gripping roller and the radius of the convex raceway.

32. The freewheel mechanism according to claim 31, wherein it contains the rolling-and-rotating rollers and the rolling-and-gripping rollers rigidly connected with each other.

33. The freewheel mechanism according to claim 31, wherein it contains the convex raceway situated on the external surface of the convex raceway core.

34. The freewheel mechanism according to claim 31, wherein it contains the concave paths, which are situated on the rolling-and-rotating ring.

35. The freewheel mechanism according to claim 31, wherein it contains the concave paths, which are situated on the type II rolling-and-rotating ring.

36. The freewheel mechanism according to claim 31, wherein it contains the rotary interlock, which contains the interlock ring, which is rotationally mounted on the interlock axle.

37. The freewheel mechanism according to claim 31, wherein it contains the rotary interlock provided with bearing, which contains the ring of interlock provided with bearing, which is mounted on the bearing, which then is mounted on the interlock axle.

38. The freewheel mechanism according to claim 31, wherein it contains the interlock axle connected with the extension arm, that is connected with the type II rolling-and-rotating ring.

39. The freewheel mechanism according to claim 31, wherein it contains the concave spring.

40. The freewheel mechanism according to claim 31, wherein it contains the concave spring, which is mating with the rolling-and-rotating roller.
